(19) United States
(12) Patent Application Publication
(10) Pub. No.: US 2022/0118708 A1
(43) Pub. Date: Apr. 21, 2022

(54) A METHOD OF PRINTING AN ENVELOPE

(71) Applicant: Hewlett-Packard Development Company, L.P., Spring, TX (US)

(72) Inventors: Alex Carruesco Llorens, Sant Cugat Del Valles (ES); Sergio Gonzalez Martin, Sant Cugat del Valles (ES); Jordi Gonzalez Rogel, Sant Cugat del Valles (ES); Leticia Rubio Castillo, Sant Cugat del Valles (ES); Yngvar Rossow Sethne, Sant Cugat del Valles (ES); Jordi Raventos Catasus, Sant Cugat del Valles (ES); Jaime Machado Neto, Sant Cugat del Valles (ES)

(21) Appl. No.: 17/418,788

(22) PCT Filed: Jul. 11, 2019
(86) PCT No.: PCT/US2019/041427

§ 371 Date: Jun. 26, 2021

(51) Int. Cl. B29C 64/393; B33Y 50/02

(52) U.S. Cl. CPC B29C 64/393; B33Y 50/02

(57) ABSTRACT

A method of printing an envelope for encapsulating at least one 3D printed object, the envelope allowing for removal of the at least one 3D printed object from an additive manufacturing system, the method comprising: monitoring a printing queue for one or more print jobs; determining a size of at least one dimension of the envelope based on the size of the one or more queued print jobs; commencing printing of the one or more queued print jobs and the envelope; and varying the size of the at least one dimension in response to changes in one or more print jobs in the printing queue.

### BACKGROUND

Additive manufacturing is transforming classical part manufacturing processes, including removing many current limitations, giving the ability to generate more complex geometries using a simpler and lower-lead time manufacturing process.

The availability of an additive manufacture system can be influenced positively or negatively by the through-put of the additive manufacture system.

### BRIEF DESCRIPTION OF THE DRAWINGS

Example implementations will now be described, by way of example, with reference to the accompanying drawings in which:

FIG. 1 is a schematic view of a 3-dimensional (3D) printing system according to example implementations;

FIG. 2A depicts a partially completed print session according to example implementations;

FIG. 2B shows a partially completed print session according to example implementations;

FIG. 2C illustrates a completed print session according to example implementations;

FIG. 3 shows an alternative completed print session according to example implementations;

FIG. 4 illustrates a flowchart according to example implementations;

FIG. 5 depicts a completed print session having incomplete 3D products according to example implementations; and

FIG. 6 illustrates machine-readable storage storing machine-executable instructions according to example implementations.

### DETAILED DESCRIPTION

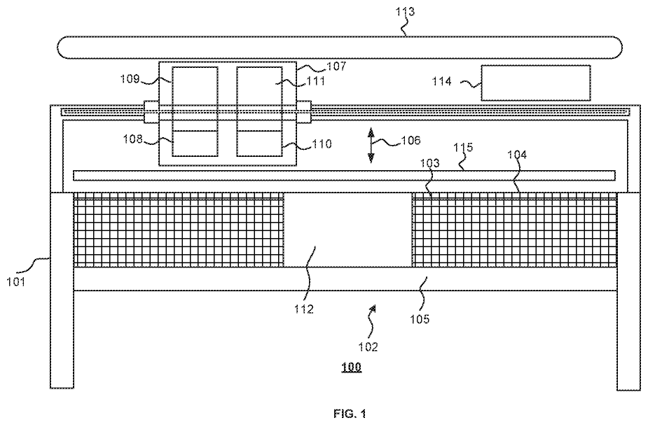

FIG. 1 shows an example of a sectional view of a 3D printing system 100. The system 100 may include a removable build unit 101 comprising a build chamber 102 within which layers of build material 103 can be accumulated to form a build material bed 104. In other examples, the build unit 101 can form a fixed part of the system 100 as opposed to being removable. The build material 103 can be, for example, a powder. In the example shown, the build chamber 102 has a build platform 105. The build platform is provided to support layers, or a volume, of build material to be selectively solidified to form each layer of a 3D object or part to be printed. The 3D printing system 100 is an example implementation of an additive manufacturing system for manufacturing a 3D object from a build material. The build platform 105 is reciprocally movable in both directions of a generally vertical axis 106.

The build chamber 102 houses the layers of fused build material as the 3D product is constructed, that is, in one implementation, it is used to house the fused and unfused build material resulting from multiple depositions of build material and selective fusing of the build material. In an alternative implementation where a binder jet system is used, the build chamber 102 is used to house the build material and the 3D object resulting from multiple depositions of a binding agent deposited upon sequential layers of the unfused material. The fused and unfused build material contained within the build chamber 102 is generally collectively known as the cake.

Examples of one or more build materials can comprise at least one of a polymer powder, or other plastic powder, a metal powder, a ceramic powder or other powder-like material, or lengths or units of such build material, taken jointly and severally in any and all permutations. The lengths or units of build material can comprise fibres, filaments or threads of build material. The fibres, filaments or threads of build material can be formed from, or otherwise derived from, longer or larger units of build material. The build material can be responsive to heat, or a binding agent, to fuse, or bind, adjacent particles of build material. For example, the build material to be fused can be defined with a printing liquid. The printing liquid can be arranged to couple heat to the build material to cause adjacent build material to fuse together. Additionally, or alternatively, the printing liquid may cause or influence chemical binding of the build material. Furthermore, the chemically bound build material can be subjected to heat to fuse the chemically bound build material together. For example, build material can comprise polypropylene, polyester, polyamide such as, for example, PA11, PA12, polylactic acid, thermoplastic polyurethane (TPU) or the like. In the further alternative only the binder agent itself is cured by for example heat or chemical reaction, forming a matrix of build material.

The system 100 can also comprise a printhead carriage 107 that has one or more than one printheads for printing liquids. For example, the system 100 can provide a first printhead 108 in communication with a first reservoir 109 of a first printing liquid. Example implementations can be realised in which the printing liquid is an energy absorbing fusing agent. The system can also provide a second printhead 110. The second printhead 110 can be in communication with a second reservoir 111 of a second printing liquid. Example implementations can be realised in which the second printing liquid can be a detailing agent.

At least one, or both, of the first and second printheads 108 and 110 can be used to influence use of the build material to construct one or more than one 3D printed object 112. For example, the fusing agent printed via the printhead108 can define the build material to be fused.

After the fusing agent has been printed onto a layer of build material, a heater such as, for example, a fusing lamp 113, can be used to heat the build material. Build material bearing fusing agent absorbs more energy than build material without fusing agent such the former agglomerates whereas the latter does not fuse. The fusing lamp 113 is an example implementation of a heat source.

The detailing agent can be used to improve the definition between fused and unfused portions of build material during heating. The detailing agent is printed onto build material intended to remain unfused that is adjacent to build material intended to be fused. The detailing agent influences the temperature of the build material onto which it is printed to inhibit fusing of that build material. The detailing agent can constrain thermal bleed, that is, it can constrain the inadvertent spread of heat to build material intended to remain unfused.

To achieve good selectivity between the fused and unfused portions of a build material layer, the fusing agent can absorb enough energy to increase the temperature of any build material coated or printed with the fusing agent above the melting or softening point of the build material, while unprinted portions of the layer of build material remain below the melting or softening point.

A controller 114 controls the operation of the 3D printer 100. The controller 114 can comprise one or more than one processor for executing machine-readable or machine-executable instructions for realizing any and all examples herein. Accordingly, examples provide at least one or more than one of circuitry, hardware or software, taken jointly and severally in any and all permutations, for implementing such a controller 114 to implement or execute any such instructions. The controller 114 is arranged to implement any control and/or any methods described herein.

The build material 103 is deposited via a recoater 115. The recoater 115 is arranged to deposit a layer of build material, such as layer 103, during a traversal of the build plafform 105. The recoater 115 traverses the width of the build platform 105 in order to deposit a layer of build material 103 substantially across the width of the build platform 105. Layer 103 is an example of such a layer of build material. The recoater 115 moves in a reciprocating manner depositing build material in a direction normal to the plane of FIG. 1.

As the one or more than one 3D product 112 is progressively printed, the build platform 105 descends through the build chamber in a direction of the axis 106. The build platform 105 descends once processing of a whole layer is complete. As the build plafform 105 progressively descends within the build chamber 102 due to the layer-by-layer construction of one or more than one 3D printed object such as object 112 shown in FIG. 1, the build chamber will progressively fill with a combination of unfused build material and fused build material; the latter being the 3D printed object(s) under construction.

Due to the additive nature of the process the 3D product(s) is at least partially surrounded in build material as it is constructed. This can lead to the 3D product(s) retaining heat for a long duration after the build is completed. In order to prevent distortion of the 3D product(s), or to imbue the 3D product(s) with a particular predetermined characteristic, the rate of cooling of the 3D product(s) can be controlled. Controlling the rate of cooling can take a long time. If the 3D product(s) is left to cool inside the build chamber this can result in the system being rendered unavailable for subsequent print jobs.

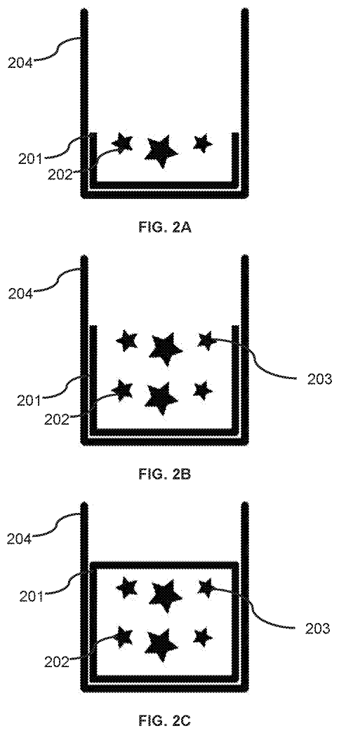

Referring to FIGS. 2A, 2B, and 2C, in order to allow the system to be made available sooner an envelope 201 can be printed around the one or more than one 3D printed object 202. The envelope 201 comprising at least one wall defining a volume sufficient to hold the 3D product(s) 202 and, in some alternative implementations, a proportion of the build material, or further alternatively, all of the build material in the case where the 3D envelope 201 is printed on the boundaries of the build chamber 204.

The at least one wall may be solid or fenestrated, such as using a lattice type structure. Fenestrations may be provided in a regular pattern, such as a grid having regular apertures, for example shaped as a rhombus. Alternatively, the fenestrations may be irregular, both in number (any number from at least one to a plurality of fenestrations) or in shape (it will be apparent that any suitable dimension or shape may be selected, including but not limited to any regular polygon, irregular polygon, circle, or ellipse, or combination thereof).

The fenestrations should be sized to minimize the use of build material for the envelope (the greater the number and/or size of fenestrations the less build material is used in printing the envelope). The fenestrations can be sized accordingly to various implementations, such that the envelope retains the solidified and non-solidified build material contained within the envelope (i.e. the build material cannot readily pass through the fenestrations) or such that the non-solidified build material can escape the envelope via the fenestrations. The build material retained in the envelope provides a supporting function, preventing distortion of the 3D product(s) as well as contributing to the control of the cooling rate (for example a greater amount of building material retained in the envelope may result in a longer cooling time).

The envelope 201 may be formed in as any suitable 3D shape to provide a sufficient volume to house the one or more than one 3D product, examples of which include, but are not limited to: a regular prism; an irregular prism; a dome; a sphere; an ellipsoid; a hemi-ellipsoid; a cone; a cylinder; a hexahedron.

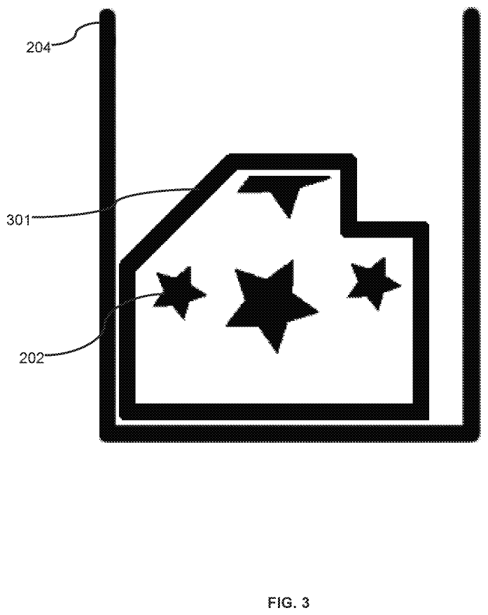

With reference to FIG. 3, alternatively, the additive manufacturing system may calculate an envelope 301 having a geometry that substantially corresponds to the form of the at least one print job(s) 202 plus a margin.

The purpose of the envelope is to allow the 3D object(s) to be removed from the additive manufacturing system 100 soon after, or even immediately following, completion of printing. This allows the relevant part of the additive manufacturing system 100 (such as the build chamber 102) to be used for a subsequent print job (i.e. printing a new batch of one or more than one 3D product(s) in a print queue). The 3D product(s), contained within the envelope, may be removed, for example, from a 3D printer, or from the build chamber 102 and relocated to a suitable area to allow the 3D product(s) sufficient time to cool and without distortion (such as in a cooling box).

The dimensions of the envelope are determined by the additive manufacturing system 100 such that the volume of the envelope is suitable for retaining the 3D product(s) and a minimum amount of build material. By way of example, the minimum amount of build material defines a margin about the 3D product(s) sufficient such that the envelope does not contact or interfere with the 3D product(s), and/or that there is sufficient build material to maintain a given cooling rate, and/or that there is sufficient build material to support a given batch of 3D product(s). As the additive manufacturing system 100 applies layers of building material to sequentially construct one or more than one 3D product(s) the envelope 201 is also constructed from the same series of layers. The number of envelope printing layers is the sum of the print job layers plus at least one margin. The margin comprising a number of additional layers of build material.

In order to maximize the usage of the additive manufacturing system multiple 100 3D products 202 may be printed in a single printing session, until the available printing volume is used up (for example until the build chamber 102 is filled). Users may add instructions for 3D products 202 to a print queue and the additive manufacturing system determines from those instructions how many 3D products 202 may be printed in a given batch (i.e. a single print session such that the available print volume of the additive manufacturing system 100 is maximized). The instructions for at least one of the 3D objects may not be received prior to commencing a printing session, especially as printing may take place over a large time frame (such as a few to many hours). New instructions, or changes to instructions may be received during the printing session.

The controller 114 is arranged to output control signals to or to receive signals from other components of the additive manufacturing system 100 or a wider network of user terminals from which a user may submit, remove, or change instructions for a 3D product. Examples of changes to instructions include, but are not limited to, addition of a print job, subtraction of a print job, cancellation of a print job, and cancellation of a partially printed print job. Such instructions are stored by the controller in a print queue. The controller 114 can also comprise a communication line or bus for communicating with a further controller (not shown). The further controller can, for example, control or otherwise orchestrate the operation of the 3D printer 100 as a whole. The controller 114 can be an example of such a further controller.

With respect to the envelope 201, the addition of instructions for 3D products (i.e. a print job) to a print queue of the additive manufacturing system means that the additive manufacturing system may need to recalculate the dimensions of the envelope so that all of the 3D products 202 instructed to be printed in that print session can be accommodated in the volume of the envelope 201 including an adequate margin. A recalculation of the dimensions of the envelope may not be necessary if the newly instructed 3D products can be located within the dimensions of the envelope as first calculated (e.g. where the newly instructed 3D product can fit next to, or be nested within, the other earlier instructed 3D products). The same is true if an instructed 3D product is subsequently cancelled, the other instructed 3D objects may require the dimensions of the envelope to be maintained at the size as initially determined.

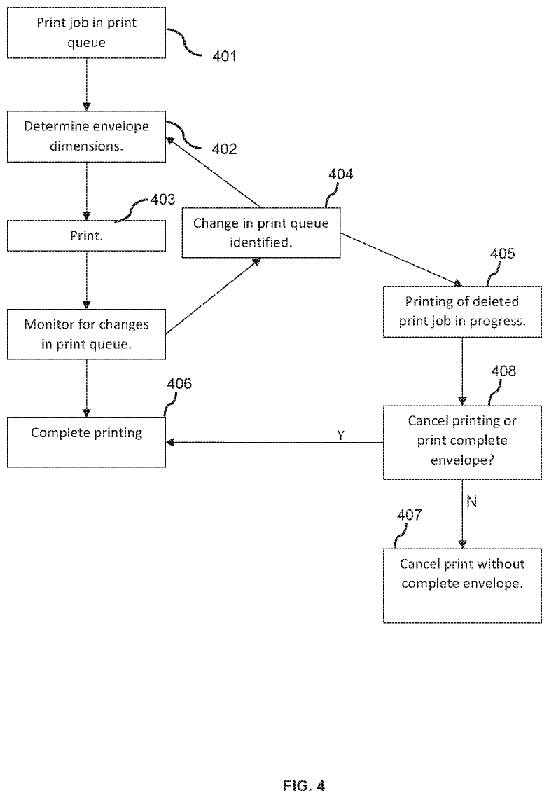

With refence to FIG. 4, the additive manufacturing system 100 achieves this by monitoring a print queue 401 for new 3D product instructions. On receipt of new instructions in the queue the additive manufacturing system 100 determines at least one dimension of the envelope 402 (varying the at least one dimension alone may be sufficient to produce an envelope of sufficient volume to house the 3D products produced in the print session especially if the envelope is a regular volume such as a hexahedron where the length between the hexagonal faces is varied), the additive manufacturing system 100 then commences the printing session 403 and commences printing of the 3D product. Concurrently to the printing of the first instructed 3D product in the print queue, the additive manufacturing system commences printing the envelope.

If additional instructions for 3D products are received 404 in the print queue once the printing session 403 has commenced the additive manufacturing system 100 recalculates the at least one dimension 402 of envelope to produce an envelope of sufficient volume to house the first instructed 3D product 202 and the later instructed 3D product 203. Multiple new instructions for 3D products may be received during a build and the additive manufacturing system 100 recalculates the at least one dimension 202 (for example, the at least one dimension is increased) of the envelope 201 accordingly until the available printing volume of the additive manufacturing system 100 is exceeded. Instructions for 3D products that, if added to the print session in progress, would exceed the available print volume of the additive manufacturing system 100 are left by the additive manufacturing system 100 until the next print session.

In determining whether a new set of instructions for a 3D product would exceed the available print volume the additive manufacturing system 100 also accounts for the margin and envelope layers needed to encase that new 3D product.

In the alternative, a user may decide that a 3D product should not be printed in a print session and remove the instructions 404 for that 3D product from the print queue. If the print session has already commenced, the additive manufacturing system detects the removal of the instructions from the print queue 404, and consequently recalculates the at least one dimension of the envelope 402 to house the 3D products remaining in that print session (for example the at least one dimension is decreased).

Additional 3D product instructions may be added 404 to the print queue following the earlier removal 404 of 3D product instructions, in which case the additive manufacturing system 100 further recalculates the at least one dimension of the envelope 201. The determination of the at least one dimension 402 of the envelope can be considered to be determined “on the fly” in response to changes in the instructions 404 for 3D products in the print queue.

In the circumstance where a user removed instructions for a 3D product from a print queue, but where the additive manufacturing system has commenced printing of that removed 3D product 405, the additive manufacturing system 100 can suitably progress to the next 3D product leaving a suitable margin of building material between the partially-completed 3D product and the next 3D product. Alternatively, if there are no further instructions for 3D printed products in the queue following the removed instructions the additive manufacturing system can recalculate the at least one dimension 402 of the envelope, complete printing of the build envelope 201, and hence the printing session 406. The system may or may not leave a suitable margin between the partially completed 3D product and the envelope.

In a further alternative, if instructions for a 3D product are removed during the printing of that product 405, the additive manufacturing system 100 may terminate the printing process 407 without completing the envelope (and therefore not recalculating the at least one dimension).

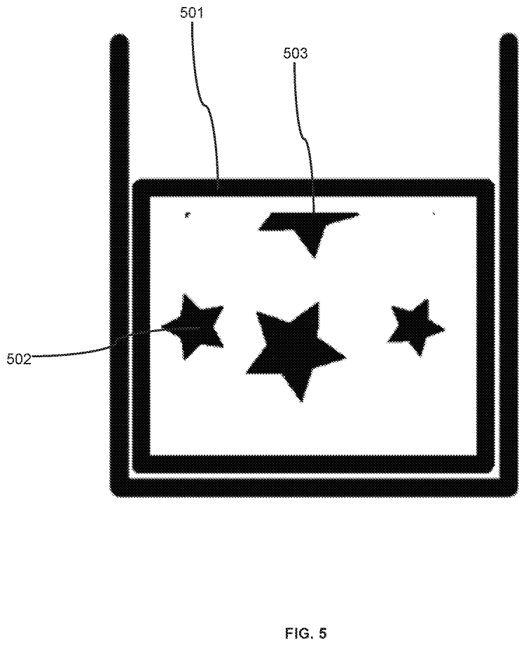

The additive manufacturing system 100 may suitably provide the user who removed the instructions for a given 3D product the choice 408 to either recalculate the at least one dimension of the envelope and complete printing the envelope or to terminate the print session without completing printing of the envelope. Such a choice allows other completed 3D products in the available build volume to be encased in an envelope 201 or to not expend further time and simply terminate the build session without using additional build material. FIG. 5 shows such a completed envelope 501 comprising complete 3D products 502 and incomplete 3D products 503. A margin may be left between the incomplete 3D products 503 and the envelope 501.

Once the printing session has completed the envelope 201 may be removed from the additive manufacturing system and relocated to a suitable area to allow the one or more than one 3D products to cool at an appropriate cooling rate while leaving the additive manufacturing system 100 free to commence a new subsequent printing session.

Once an appropriate period of time has elapsed for the one or more than one 3D product(s) contained in the envelope 201 to have sufficiently cooled the envelope 201 may be opened and the 3D product(s) 202, 203 removed from the envelope. If, as per alternative implementations, a proportion of build material is contained within the envelope 201, the proportion of build material may be disposed of, or recycled on opening the envelope.

As the envelope 201 allows removal of the one or more than one 3D product(s) 202, 203 from the additive manufacturing system 100 soon or immediately after the printing session has completed. As the envelope 201 and build material contained therein can be used to control the cool down rate of the one or more than one 3D product(s) 202, 203 in the envelope, the temperature of the 3D product(s) 202, 203, on removal of the envelope from the additive manufacturing system 100, may exceed a thermally stable temperature. The thermally stable temperature is a temperature limit outside of which the 3D product(s) 202, 203 may deform in shape or develop undesirable properties (mechanical properties for instance). The envelope 201 therefore allows the removal of the one or more than one 3D product(s) 202, 203 from the additive manufacturing system 100 without compromising the desired properties of the finished 3D product(s) 202, 203.

Influencing or otherwise controlling the temperature of the build material within an envelope provides control over a predetermined characteristic of the 3D object under construction. The predetermined characteristic can be influenced at least by the rate of cooling of the 3D printed object.

Example implementations can be realised in which the predetermined characteristic is associated with at least one, or both, of dimensional stability or dimensional accuracy. Alternatively, or additionally, example implementations can be realised in which the predetermined characteristic is associated with at least a mechanical property. For example, the envelope can be designed or selected to realise a predetermined cooling rate of at least one, or both, of the fused or unfused material in the portion of the cake contained within the envelope. Example implementations can be realised in which a target temperature is selected to maintain the fused build material at or above a respective crystalisation temperature of that fused build material for a predetermined period of time.

Example implementations can be realised in which the target temperature is associated with a type of build material used. For example, a given type of build material, such as, for example, PA11, may have a respective target temperature such as, for example, 185C or some other target temperature. Another, different, type of build material, such as, for example, PA12 may have a different target temperature such as, for example, 150C or some other target temperature.

The processing and control represented in FIG. 4 can be implemented via machine executable instructions for execution by at least one processor. The at least one processor can comprise the controller 114 or some other processor or controller such as, for example, the above-described controller 114.

Example implementations of the system 100 can be realised in the form of machine-executable instructions arranged, when executed by a machine, to implement any or all aspects, processes, activities or flowcharts, taken jointly and severally in any and all permutations, described in this application. It will be appreciated that circuitry as used herein can comprise one or more than one of physical electronic circuitry, software, hardware, application specific integrated circuitry or FPGAs, taken jointly or severally in any and all permutations.

Therefore, implementations also provide machine-readable storage storing such machine-executable instructions. The machine-readable storage can comprise transitory or non-transitory machine-readable storage. The machine can comprise one or more processors, or other circuitry, for executing the instructions or implementing the instructions.

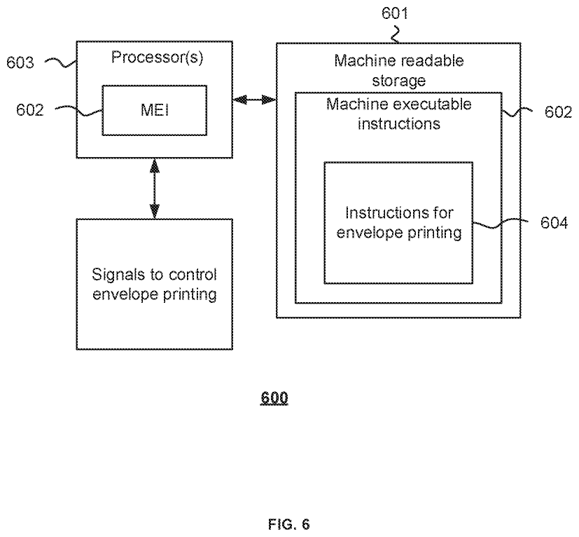

Accordingly, referring to FIG. 6, there is shown a view 600 of implementations of at least one, or both, of machine-executable instructions or machine-readable storage. FIG. 6 shows machine-readable storage 601. The machine-readable storage 601 can be realized using any type of volatile or non-volatile storage such as, for example, memory, a ROM, RAM, EEPROM, or other electrical storage, or magnetic or optical storage or the like. The machine-readable storage 601 can be transitory or non-transitory. The machine-readable storage 601 stores machine-executable instructions (MEIs) 602. The MEIs 602 comprise instructions that are executable by a processor or other instruction execution, or instruction implementation, circuitry 603. The processor or other circuitry 603 is responsive to executing or implementing the MEIs 602 to perform any and all activities, processes, operations or methods described, illustrated and/or claimed in this application. Example implementations of the MIEs 602 comprise machine-executable instructions 604 for printing an envelope and determining at least one dimension of the envelope during printing in response to changes in printing instructions as described herein.

The controller 114 can be an implementation of the foregoing processor or other circuitry 603 for executing any such MEIs 602.

Further example implementations can be realised according to the following feature sets:

Feature set 1: An additive manufacturing system for manufacturing a 3D printed object from a build material; the system comprising a controller arranged to: receive printing instructions for one or more 3D printed objects; simultaneously print an envelope and the one or more 3D printed objects, the envelope arranged around the one or more 3D printed objects; the controller further arranged to determine a size of the envelope during printing; and vary the size in response to changes to the printing instructions.

Feature set 2: An additive manufacturing system as claimed in feature set 1 wherein the controller receives changes to the printing instructions during printing.

Feature set 3: An additive manufacturing system as claimed in feature set 1 wherein the controller is arranged to print an envelope such that the envelope encases a proportion of the build material with the one or more 3D printed objects.

Feature set 4: An additive manufacturing system as claimed in feature set 1 wherein the controller is arranged to print an envelope comprising at least one wall.

Feature set 5: An additive manufacturing system as claimed in feature set 4 wherein the wall comprises one or more fenestrations.

Feature set 6: An additive manufacturing system as claimed in feature set 1 wherein the changes to the printing instructions is one or more selected from the list of: addition of a 3D printed object; subtraction of a 3D printed object; cancellation of a 3D printed object; and cancellation of a partially printed 3D object.

Feature set 7: An additive manufacturing system as claimed in feature set 6, wherein, when the change to the one or more 3D printed objects is cancellation of a partially printed 3D object, the controller is arranged to complete printing the envelope.

Feature set 8: An additive manufacturing system as claimed in feature set 1 wherein the controller is arranged to form the envelope from one or more envelope layers and to form the 3D printed object from one or more 3D printed object layers, wherein the controller determines the number of envelope layers by adding at least one margin layer to the one or more 3D printed object layers.

Feature set 9: An additive manufacturing system as claimed in feature set 1 wherein the controller is arranged to print an envelope substantially corresponding in shape to any one of: a regular prism; an irregular prism; a dome; a sphere; an ellipsoid; a hemi-ellipsoid; a cone; a cylinder; a hexahedron; or the form of the one or more 3D printed objects plus a margin.

Feature set 10: A method of printing an envelope for encapsulating at least one 3D printed object, the envelope allowing for removal of the at least one 3D printed object from an additive manufacturing system, the method comprising: monitoring a printing queue for one or more print jobs; determining a size of at least one dimension of the envelope based on the size of the one or more queued print jobs; commencing printing of the one or more queued print jobs and the envelope; and varying the size of the at least one dimension in response to changes in one or more print jobs in the printing queue.

Feature set 11: A method of printing an envelope as claimed in feature set 10 wherein varying the size of the at least one dimension comprises increasing the size if one or more additional print jobs join the printing queue.

Feature set 12: A method of printing an envelope as claimed in feature set 10 wherein varying the size of the at least one dimension comprises decreasing the size if one or more queued print jobs are removed from the printing queue.

Feature set 13: A method of printing an envelope as claimed in feature set 10 further comprising completing printing of the envelope once the one or more queued print jobs are fulfilled.

Feature set 14: The method of printing an envelope as claimed in feature set 10, further comprising determining if printing of the one or more removed queued print jobs has commenced, and, where it is so determined, providing an option to a user to either complete the envelope or to end printing.

Feature set 15: Machine-readable storage storing machine-executable instructions arranged, when executed, to control a 3D; the machine-executable instructions comprising: monitoring a printing queue for one or more print jobs; determining a size of at least one dimension of the envelope based on the size of the one or more queued print jobs; commencing printing of the one or more queued print jobs and the envelope; and varying the size of the at least one dimension in response to changes in one or more print jobs in the printing queue.

Although example implementations have been described with reference to the unfused supply build material being stored within the lower portion of the build chamber beneath the build platform, example implementations are not limited to such arrangements. Example implementations can be realised in which the unfused supply build material is stored within a hopper. The hopper can be separate from the build chamber as opposed to being an integral part of the build chamber.

1. An additive manufacturing system for manufacturing a 3D printed object from a build material; the system comprising a controller arranged to: receive printing instructions for one or more 3D printed objects; simultaneously print an envelope and the one or more 3D printed objects, the envelope arranged around the one or more 3D printed objects; the controller further arranged to determine a size of the envelope during printing; and vary the size in response to changes to the printing instructions.

2. An additive manufacturing system as claimed in claim 1 wherein the controller receives changes to the printing instructions during printing.

3. An additive manufacturing system as claimed in claim 1 wherein the controller is arranged to print an envelope such that the envelope encases a proportion of the build material with the one or more 3D printed objects.

4. An additive manufacturing system as claimed in claim 1 wherein the controller is arranged to print an envelope comprising at least one wall.

5. An additive manufacturing system as claimed in claim 4 wherein the wall comprises one or more fenestrations.

6. An additive manufacturing system as claimed in claim 1 wherein the changes to the printing instructions is one or more selected from the list of:
addition of a 3D printed object; subtraction of a 3D printed object; cancellation of a 3D printed object; and cancellation of a partially printed 3D object.

7. An additive manufacturing system as claimed in claim 6, wherein, when the change to the one or more 3D printed objects is cancellation of a partially printed 3D object, the controller is arranged to complete printing the envelope.

8. An additive manufacturing system as claimed in claim 1 wherein the controller is arranged to form the envelope from one or more envelope layers and to form the 3D printed object from one or more 3D printed object layers, wherein the controller determines the number of envelope layers by adding at least one margin layer to the one or more 3D printed object layers.

9. An additive manufacturing system as claimed in claim 1 wherein the controller is arranged to print an envelope substantially corresponding in shape to any one of: a regular prism; an irregular prism; a dome; a sphere; an ellipsoid; a hemi-ellipsoid; a cone; a cylinder; a hexahedron; or the form of the one or more 3D printed objects plus a margin.

10. A method of printing an envelope for encapsulating at least one 3D printed object, the envelope allowing for removal of the at least one 3D printed object from an additive manufacturing system, the method comprising: monitoring a printing queue for one or more print jobs; determining a size of at least one dimension of the envelope based on the size of the one or more queued print jobs; commencing printing of the one or more queued print jobs and the envelope; and varying the size of the at least one dimension in response to changes in one or more print jobs in the printing queue.

11. A method of printing an envelope as claimed in claim 10 wherein varying the size of the at least one dimension comprises increasing the size if one or more additional print jobs join the printing queue.

12. A method of printing an envelope as claimed in claim 10 wherein varying the size of the at least one dimension comprises decreasing the size if one or more queued print jobs are removed from the printing queue.

13. A method of printing an envelope as claimed in claim 10 further comprising completing printing of the envelope once the one or more queued print jobs are fulfilled.

14. The method of printing an envelope as claimed in claim 10, further comprising determining if printing of the one or more removed queued print jobs has commenced, and, where it is so determined, providing an option to a user to either complete the envelope or to end printing.

15. Machine-readable storage storing machine-executable instructions arranged, when executed, to control a 3D printer; the machine-executable instructions comprising: monitoring a printing queue for one or more print jobs;
determining a size of at least one dimension of the envelope based on the size of the one or more queued print jobs; commencing printing of the one or more queued print jobs and the envelope; and varying the size of the at least one dimension in response to changes in one or more print jobs in the printing queue.
